(19) United States
(12) Patent Application Publication
(10) Pub. No.: US 2025/0304311 A1
(43) Pub. Date: Oct. 2, 2025

(54) BEVERAGE CUP, A BEVERAGE CUP BLANK AND/OR A METHOD OF MANUFACTURING THE SAME

(71) Applicant: Jonathan Bond, Yorkshire (GB)

(72) Inventor: Jonathan Bond, Yorkshire (GB)

(21) Appl. No.: 19/090,788

(22) Filed: Mar. 26, 2025

(30) Foreign Application Priority Data
Mar. 26, 2024 (GB) 2404274.9

(51) Int. Cl. B65D 3/28; B31B 50/83; B31B 110/10; B65D 3/06; B65D 25/56; B65D 65/46

(52) U.S. Cl. CPC B65D 3/28; B31B 50/83; B65D 3/06; B65D 25/56; B65D 65/466; B31B 2110/10

(57) ABSTRACT

A beverage cup is provided. The beverage cup has a main body formed from paper and/or paper board material. At least one window element is defined in a side wall of the main body of said beverage cup. The at least one window element comprises or consists of at least a partially transparent, biodegradable and/or compostable material.

### CROSS-REFERENCE TO RELATED APPLICATIONS

This application claims priority under 35 USC § 119 to GB Application Serial No. 2404274.9, filed on Mar. 26, 2024, which is herein incorporated by reference in its entirety including without limitation, the specification, claims, and abstract, as well as any figures, tables, or examples thereof.

### SUMMARY

This invention relates to a beverage cup, a beverage cup blank and/or to a method of manufacturing the same.

Although the following description refers almost exclusively to a beverage cup for the containment of a cold alcoholic beverage, it will be appreciated by persons skilled in the art that the beverage cup of the present invention could be used for serving cold non-alcoholic beverages, hot alcoholic or hot non-alcoholic beverages and/or any type of beverage or liquid.

Single-use plastic products, such as beverage cups, which are used once, often for a short period of time, before being thrown away, have been shown to have a significant negative impact on the environment, wildlife and on human health, both nationally and globally. As a result, legislation has now been brought in to many countries and regions of the world to outlaw the use of single-use plastics, particularly where sustainable alternatives might be available.

As such, it is now a requirement for single use plastic beverage cups to be replaced with paper based products that are 100% biodegradable and/or compostable. Thus, it is now commonplace to use biodegradable paper cups for beverage containment. However, a problem with paper cups is that due to the opaqueness of paper, it is impossible to calculate the level of liquid in the cup when viewing the cup from a side angle. Even if the cup is viewed from above, it is often difficult for a user to accurately assess the volume of liquid contained in the cup, particularly if the cup has a lid or if foam or a head is present on the liquid contained in the cup. This is particularly the case, for example, with a carbonated drink or a drink being dispensed from pressurised beverage dispensing means, such as beer. Many countries in the world have weights and measurement legislation to ensure correct volumes of beverage are dispensed in to containers, particularly for alcoholic beverages. When conventional transparent plastic cups are used to contain alcoholic beverages, it is relatively easy for a user to determine if a correct volume of alcoholic beverage had been dispensed into the cup because they can easily visualise the uppermost liquid level in the cup simply by looking through a side wall of the transparent plastic cup. However, the opaqueness of paper cups prevents this simple visual inspection. In order to overcome this problem, metered beverage dispensing apparatus could be used. However, metered beverage dispensing apparatus is generally expensive. There is therefore a need to allow correct measures of beverage to be dispensed into paper based cups using free flow or non-metered dispensing apparatus.

CN213229354 discloses a paper cup comprising a visible plastic window in the side wall of the cup to allow the interior of the paper cup to be visible. However, as the window is made from plastic, this prevents the paper cup from being 100% biodegradable and/or compostable. As such, this cup design does not meet the new legislation which requires single use beverage cups to be 100% biodegradable and/or compostable.

It is therefore an aim of the present invention to provide a beverage cup that overcomes the abovementioned problems.

It is a further aim of the present invention to provide a beverage cup that can be formed into a beverage cup that overcomes the abovementioned problems.

It is a yet further aim of the present invention to provide a method of manufacturing a beverage cup that overcomes the abovementioned problem.

According to a first aspect of the present invention there is provided a beverage cup, said beverage cup having a main body formed from paper and/or paper board material, at least one window element defined in a side wall of the main body of said beverage cup, characterised in that said at least one window element comprises or consists of at least a partially transparent, biodegradable and/or compostable material.

Thus, by providing the at least one window element from biodegradable and/or compostable material which is at least a partially transparent, this fulfils the requirements of allowing both a user to identify the uppermost liquid line within the interior of the beverage cup via the window element and allowing the entire beverage cup to be biodegradable and/or compostable.

Preferably the transparency of the at least partial transparent biodegradable and/or compostable material is sufficient to allow a user to view a liquid line of the liquid contained in the interior of the beverage cup through the at least one window element from an exterior of the beverage cup in use.

In one embodiment the at least one window element comprises or consists of a fully transparent or substantially fully transparent biodegradable, recyclable and/or compostable material.

Preferably the beverage cup or the main body of the beverage cup is formed from a biodegradable, recyclable and/or compostable paper and/or paper board material.

Preferably the beverage cup, the main body of the beverage cup and/or the partially transparent biodegradable and/or compostable material of the at least one window element is equal to or greater than 90% biodegradable, recyclable and/or compostable; equal to or greater than 95% biodegradable, recyclable and/or compostable; equal to or substantially equal to 100% biodegradable, 100% recyclable and/or 100% compostable (for example, at home or industrially).

Preferably the at least one window element comprises or consists of a material that is entirely plastic-free and/or PFAS (per- or poly-fluoralkyl substances) free.

Preferably the material from which the main body of the beverage cup is formed is the same material or same type of material as the at least one window element. This makes the beverage cup a single material cup, which is necessary for the cup to be fully biodegradable and/or compostable.

In one embodiment the material from which the main body of the beverage cup and/or the window element is formed is SYLVICTA® (supplied by Fedrigoni Special Papers). This material typically acts as a barrier against mineral oils, oxygen, aroma, grease and water.

In one example, the material from which the main body of the beverage cup and/or the window element is formed from, consists or includes an uncoated or coated translucent barrier paper.

In one example, the material from which the main body of the beverage cup and/or the window element is formed from, consists or includes cellulose fibers, cellulose virgin fibers, and further preferably this is sourced by PEFC and FSC certified wood pulp.

In one embodiment the material include a bio-coating based on natural polymers.

Preferably the at least one window element and/or the main body of the beverage cup is formed from, includes or consists of any or any combination of paper material, paper board material, corn starch paper or paper board, plant based paper or paper board, wood based material, cellulose based material, polylactic acid (PLA) paper or paper board, PLA coated paper or paper board and/or the like.

In one embodiment the at least one window element is or consists of a single window element only defined in or provided in the beverage cup or the main body of the beverage cup.

In one embodiment the at least one window element is or consists of at least two window elements defined in or provided in the beverage cup or main body of the beverage cup, and further preferably the at least two window elements are provided directly opposite to each other on side walls of the beverage cup or main body of the beverage cup. This allows a user to see an uppermost liquid/beverage level in the interior of the cup in use via the window element irrespective of which side of the beverage cup the user is facing.

In one embodiment the at least one window element is of such size, design and/or shape to allow a liquid level to be viewed through the same but which does not compromise the overall integrity of the beverage cup. For example, if the at least one window element is too large, this will compromise the structural rigidity and strength of the beverage cup. If the at least one window element is too small, this will prevent easy visualisation of the liquid level contained within the beverage cup.

In one embodiment the shape, design and/or size of the at least one window element is such that a longitudinal axis or the longest axis of the at least one window element is parallel to or substantially parallel to a height or a longitudinal axis of the beverage cup in use. For example, at least one window element could be rectangular or substantially rectangular in shape with a long axis of the rectangle parallel or substantially parallel to a height or longitudinal axis of the beverage cup.

In one embodiment the width of the at least one window element is approximately 15 mm+/−5 mm. Preferably the width is typically an axis parallel or substantially parallel to a base of the beverage cup.

In one embodiment the length or height of the at least one window element is approximately 30 mm+/−5 mm. Preferably the height is typically an axis parallel to substantially parallel to a height or longitudinal axis of the beverage cup, or transverse or perpendicular to a base of the cup.

In one embodiment one or more measurement markings are printed on, provided on and/or defined on the beverage cup, main body of the beverage cup and/or at least one window element so that a user is able to determine a quantity or product or volume of liquid contained in the beverage cup in use. For example, a line with a unit of measurement could be printed on a side wall of the cup adjacent to the at least one window element and/or on the at least one window element itself.

Preferably at least one aperture is defined in the side wall of the beverage cup or the main body of the beverage cup to at least partially form the at least one window element. Further preferably the at least partially transparent biodegradable and/or compostable material is provided over or in the at least one aperture to form the window element of the completed beverage cup.

Preferably the at least one window element or the at least partially transparent biodegradable and/or compostable material is adhered to, sealed to or heat sealed to the beverage cup material to prevent any liquid leakage through the at least one window element in use.

In one embodiment the at least partially transparent biodegradable and/or compostable material covering the at least one aperture is attached to the beverage cup via suitable attachment means, such as for example, via adhesive, heating and/or pressure sealing adhesive, heat sealing coating or adhesive, plant based adhesive, food safe adhesive and/or the like.

In one embodiment the beverage cup, the main body of the beverage cup and/or at least one window element is formed from or consists of a single layer or ply of material.

In one embodiment the material from which the at least one window element is formed is heat sealed to the material from which the main body of the beverage cup is formed (i.e. the at least one window element is heat sealed to the main body of the beverage cup in use) in order to attach the two together.

Preferably the heat sealing coating on the material is a starch based coating.

In one embodiment the beverage cup, the main body of the beverage cup and/or the at least one window element is formed from a multi-layered or multi-ply material.

In one example, the at least partially transparent biodegradable and/or compostable material of the window element is attached or joined between two or more layers of the multi-layered paper and/or paper board material of the beverage cup or main body of the beverage cup.

In one embodiment the beverage cup, the main body of the beverage cup and/or at least one window element is formed from a two-ply or two layered material, or a three-ply or three layered material. However, any number of layers of material can be used to form the beverage cup, the main body of the beverage cup and/or at least one window element as required.

In one embodiment at least one layer of the material of the beverage cup, the main body of the beverage cup, the side walls of the beverage cup and/or at least one window element is corrugated or includes one or more corrugations on an external surface thereof. This typically provides the beverage cup with heat insulation properties.

In one embodiment at least one layer, an outer layer, an inner layer or all the layers of the material of the beverage cup, the main body of the beverage cup and/or at least one window element is a smooth or substantially smooth paper and/or board material. For example, the material from which the beverage cup, the main body of the beverage cup and/or at least one window element is formed from or consists of can be free of corrugations.

Preferably the beverage cup, the main body of the beverage cup and/or the at least one window element is formed from, includes or consists of sheet material, sheet like material, film material and/or film like material.

Preferably the material, shape and/or design of the beverage cup is such that when the beverage cup is constructed, it is rigid or substantially rigid in use.

In one embodiment the beverage cup is arranged so as to allow containment of a hot liquid or a hot beverage. For example, the beverage cup can be arranged to contain a liquid above room temperature (i.e. above 21 degrees Celsius) in use.

In one embodiment the beverage cup is arranged so as to allow containment of a cold liquid or a cold beverage. For example, the beverage cup can be arranged to contain a refrigerated liquid or a liquid at or below room temperature (i.e. at or below 21 degrees Celsius).

Preferably the beverage cup, the main body of the beverage cup and/or at least one window element is formed from or includes a coating or a coated material. For example, the beverage cup or main body of the beverage cup can be made from a coated paper board material.

Preferably the at least one coating is a waterproof or substantially waterproof coating. For example a polylactic acid (PLA) coating could be used.

In one embodiment the beverage cup can be any suitable size, shape and/or design to allow a required unit of measurement of beverage to be securely contained therein. For example, the beverage cup could be a pint sized cup, a half pint sized cup and/or the like.

Preferably the beverage cup or the main body of the beverage cup is formed from a blank of material, and further preferably is formed from a blank of paper board and/or paper material.

Preferably the beverage cup blank or main body beverage cup blank is movable from a flat or relatively flat form to an erect or relatively erect form in order to construct the beverage cup in use.

Preferably the blank of material is erected to form the beverage cup using cup forming apparatus.

In one embodiment the beverage cup or main body of the beverage cup is formed from a first blank of material that is used to construct side walls of the beverage cup and a second blank of material that is used to construct a base of the beverage cup.

Preferably the at least one aperture defined in or cut in the beverage cup that forms the at least one window element is defined in the first side wall blank of material.

Preferably the at least one aperture is defined in the first side wall blank of material before the beverage cup is constructed/erected in use.

In one embodiment an exterior surface of the beverage cup or beverage cup/main body blank is printed with one or more images, designs, text and/or the like.

In one embodiment the beverage cup comprises a side wall or walls and a base.

Preferably the base is joined to or via a first or lower edge of the side wall or walls.

Preferably a second or upper edge of the side wall or walls defines an open top to the beverage cup.

Preferably the base of the beverage cup is opposite to the open top of the beverage cup.

Preferably a beverage or a liquid is poured into the beverage cup via the open top in use.

In one embodiment a lid or removable lid can optionally be provided over the open top of the beverage cup in use.

Preferably the lid engages over or with the second or upper edge of the side wall or walls of the beverage cup in use.

In one embodiment the second or upper edge of the side wall or walls of the beverage cup is a rolled edge or lip.

Preferably the at least one window element or aperture for the at least one window element is provided below or a spaced distance below the rolled edge or lip of the cup.

Preferably the beverage cup has a narrowing taper towards the base of the cup when constructed in use.

According to a second aspect of the present invention there is provided a beverage cup material blank, said beverage cup material blank formed from paper and/or paper board material, at least one window element defined in the beverage cup material blank, and wherein said at least one window element comprises or consists of at least a partially transparent biodegradable and/or compostable material.

Preferably the beverage cup material blank is arranged to form a main body of the beverage cup in use.

Preferably at least part of the material blank forms side wall(s) of the beverage cup when constructed in use and the at least one window element is defined in the side wall(s) of the blank.

Preferably the beverage cup blank includes a first blank of material for creating side walls of the beverage cup or a main body of the beverage cup in use, and a second blank of material for creating a base of the beverage cup or main body of the beverage cup in use.

Preferably the first and second blanks of material are joined together and assembled to form the constructed beverage cup.

Preferably the at least one window element is defined in the first blank of material for creating the side wall(s) of the beverage cup in use.

According to a further aspect of the present there is a provided a method of manufacturing a beverage cup, said method including the steps of providing a beverage cup material blank formed from paper and/or paper board material, forming at least one window element in the beverage cup material blank, constructing the beverage cup from the beverage cup material blank, and wherein said at least one window element comprises or consists of at least a partially transparent biodegradable and/or compostable material.

Preferably the step of providing a beverage cup material blank includes the step of cutting the same from a larger blank of material or roll of paper or paper board material.

Preferably the method includes cutting an aperture in the beverage cup or main body of the beverage cup for location of the at least one window element.

Preferably the beverage cup blank includes a first blank of material for creating side wall(s) of the beverage cup or main body of the beverage cup in use, and a second blank of material for creating a base of the beverage cup or main body of the beverage cup in use.

Preferably the step of constructing the beverage cup includes the step of erecting the first side wall material blank into a cup shape or cylinder. Further preferably one or more seams or edges of the material are attached, adhered, heated and/or sealed to join the same in the required cup shape.

Preferably the method includes the step of adding the second base blank of material into the erected cup shape or cylinder and joining the same to a lower or first edge of the side walls of the erect cup shape or cylinder. Further preferably one or more seams or edges of the material are attached, adhered, heated and/or sealed to join the same in the required cup shape.

Preferably the beverage cup blank(s) is/are erected into a beverage cup using cup forming apparatus. The cup forming apparatus that can be used in the present invention can be any conventional cup forming apparatus that is known in the technical field now or in the future.

Preferably a rolled edge or lip is created on an uppermost or second edge of the beverage cup.

In one embodiment the beverage cup is a single use item and/or is a disposable item.

### DRAWINGS

An embodiment of the present invention will now be described with reference to FIGS. 1 and 2.

FIG. 1 is a side view of a beverage cup according to an embodiment of the present invention.

FIG. 2 is a beverage cup blank for forming the beverage cup shown in FIG. 1.

### DESCRIPTION

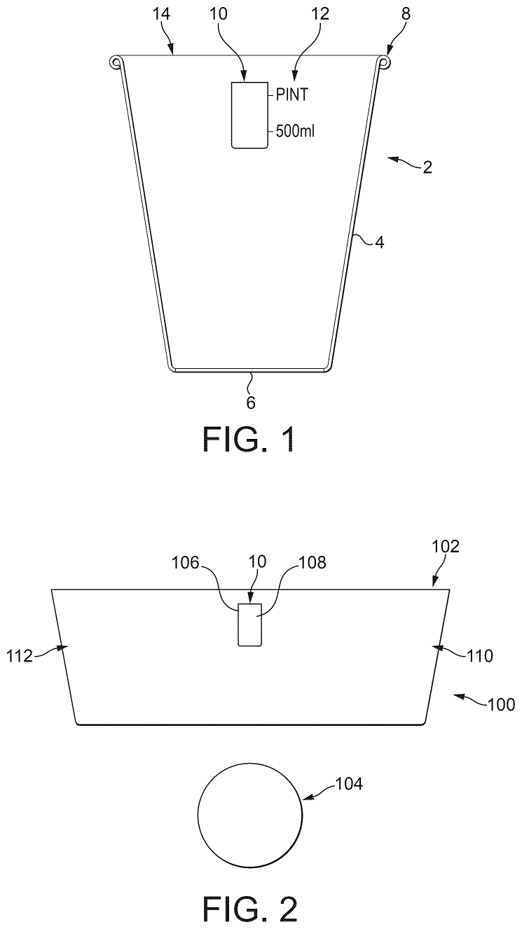

Referring to FIG. 1, there is illustrated an example of a beverage cup 2 according to an embodiment of the present invention. The beverage cup 2 has a main body including side walls 4 and a base 6. The base 6 can be joined to the side walls along a first or lower edge of the side walls. A second or uppermost edge 8 of the side walls 4 is in the form of an outwardly rolled edge or lip.

The beverage cup 2 is formed from 100% biodegradable and compostable paper board material. The paper board material can be a single ply or layer of material or can be a multi-ply or multi-layered material. It is typically provided with a biodegradable and compostable waterproof coating on an inner and/or outer surface of the same.

In accordance with the present invention, a window element 10 is defined in the side wall 4 of the beverage cup 2 below the outwardly roller edge or lip for allowing a user to view the liquid line or uppermost liquid line of the beverage contained in the cup 2 in use. This is important in ensuring an accurate volume of beverage has been dispensed into the cup 2 in use. The provision of accurate measures of beverage in a cup, particularly for example in the case of alcoholic drinks, is important because by law, such drinks are required to be provided in accurate pre-defined measures, such as a pint or half pint measure. Beverages such as beer or carbonated drinks often form a foam head on top of the uppermost liquid surface when being dispensed from pressurised dispensing apparatus. Conventionally, the formation of a foam head on a top surface of the dispensed liquid prevents a user from easily visualising the top level of the liquid in the cup when the beverage is being viewed from above via the open top of the cup. This makes it difficult for a user to accurately dispense a pre-determined drink measure unless expensive metering equipment is used.

The provision of a window element in a beverage cup is known but such conventional window elements have previously been formed from a transparent plastic material. This prevents conventional beverage cups from being fully recyclable, compostable and/or biodegradable. The window element of the present invention is formed, in one example, from a 100% biodegradable and compostable paper material which is at least partially transparent and is plastic free. The at least partial transparency of the window element material is such that the liquid line of the beverage contained in the beverage cup can be easily visualised through the window element from the exterior of the cup. This is the case even if a foam head is located on the upper surface of the liquid. This means that the beverage cup can be used with both metered dispensing apparatus and free flow dispensing apparatus (i.e. non-metered dispensing apparatus) whilst still allowing a user to accurately dispense a pre-defined measure of beverage into the cup in use.

The external surface of the cup 2 can be printed with any suitable design, images, text and/or the like.

In one example, a pre-defined measure 12 that the beverage cup is suitable to contain can be printed on or adjacent the window element 10 to allow a user to easily visualise the amount of beverage that is to be located in the beverage up in use.

A lid can optionally be provided for location over an open top 14 of the cup 2 if required. Beverage is poured into the cup 2 via the open top 14 in use.

Referring to FIG. 2, there is illustrated a beverage cup material blank 100 for forming a main body of the beverage cup 2 according to the present invention. More particularly, the beverage cup material blank 100 includes a first side wall blank 102 and a second base blank 104. The beverage cup material blanks 102, 104 are typically cut from paper and/or paper board material. Window element 10 is formed in the first side wall blank 102 adjacent to and below an upper or second edge of the same. This window element comprises an aperture 106 typically cut in the first side wall material blank 102 and a partially transparent, biodegradable and compostable paper material 108 is located over the aperture 106 and is sealingly adhered via suitable adhesive means to the side wall material blank 102. However, the material of the widow element could also be joined between an outer and an inner layer forming the side walls blanks if required.

The beverage cup blank 100 is typically moved from a relatively flat condition to a relatively erect condition to construct the beverage cup 2 using cup forming apparatus. In one example, the cup forming apparatus rolls the first side wall blank 102 to form of a cup shape or cylinder. One or more side wall edge sections 110 of the first side wall blank are sealingly adhered to one or more opposite side wall edge sections 112 of the first side wall blank. This sealing adhesion, in one example, can be via a heat sealing adhesive. The base 104 of the beverage cup 2 is then located into place in a base of the erect side walls and sealingly adhered. This adhesion, in one example, can also be via a heat sealing adhesive. A rolled edge or lip can be formed on an upper edge of the cup.

1. A beverage cup, said beverage cup having a main body formed from paper and/or paper board material, at least one window element defined in a side wall of the main body of said beverage cup, characterised in that said at least one window element comprises or consists of at least a partially transparent, biodegradable and/or compostable material.

2. The beverage cup according to claim 1, wherein the beverage cup, the main body of the beverage cup and/or the at least one window element is equal to or greater than 90% biodegradable, compostable and/or recyclable; equal to or greater than 95% biodegradable, compostable and/or recyclable; equal to or substantially equal to 100% biodegradable, recyclable and/or compostable.

3. The beverage cup according to claim 1, wherein the at least one window element is formed from, includes or consists of any or any combination of a paper or paper based material, a corn starch paper, a plant based paper, cellulose based paper, polylactic acid (PLA) paper or PLA coated paper.

4. The beverage cup according to claim 1, wherein the at least one window element consists of a single window element only defined in or provided in the beverage cup; or the at least one window element comprises or consists of at least two window elements defined in or provided in the beverage cup.

5. The beverage cup according to claim 1, wherein the shape, design and/or dimensions of the at least one window element is such that a longitudinal axis or the longest axis of the at least one window element is parallel or substantially parallel to a height or longitudinal axis of the beverage cup.

6. The beverage cup according to claim 1, wherein a width of the at least one window element is approximately 15 mm+/−5 mm; and/or a length or height of the at least one window element is approximately 30 mm+/−5 mm.

7. The beverage cup according to claim 1, wherein one or more measurement markings are printed, provided and/or defined on the beverage cup, the main body of the beverage cup and/or at least one window element so that a user is able to determine a quantity or product or volume of liquid contained in the beverage cup in use.

8. The beverage cup according to claim 1, wherein at least one aperture is defined in a side wall of the material forming the main body of the beverage cup and the material of the at least one window element is provided in or over the at least one aperture to form the at least one window element.

9. The beverage cup according to claim 1, wherein the at least one window element is attached, adhered, sealed or heat sealed to the beverage cup or main body of the beverage cup and/or is attached or joined between two or more layers or plys of the paper and/or paper board material of the main body of the beverage cup.

10. The beverage cup according to claim 1, wherein the beverage cup, the main body of the beverage cup and/or the at least one window element is formed from or consists of a single layer or ply of material or a multi-layered or multi-ply material.

11. The beverage cup according to claim 1, wherein a layer or at least one layer of material of the main body of the beverage cup and/or the at least one window element is corrugated or includes one or more corrugations on an external surface thereof and/or is formed from or includes a coating, waterproof coating, substantially waterproof coating or coating material.

12. The beverage cup according to claim 1, wherein the beverage cup or main body of the beverage cup is formed from a blank or blanks of material; and the beverage cup or main body blank is movable from a flat or relatively flat form to an erect or relatively erect form in order to construct the beverage cup in use.

13. A beverage cup material blank, said beverage cup material blank formed from paper and/or paper board material, at least one window element defined in the beverage cup material blank, characterised in that said at least one window element comprises or consists of at least a partially transparent, biodegradable and/or compostable material.

14. The beverage cup material blank according to claim 13, including a first material blank for creating a side wall(s) of the beverage cup or main body of the beverage cup, and a second material blank for creating a base of the beverage cup or main body of the beverage cup.

15. A method of manufacturing a beverage cup, said method including the steps of providing a beverage cup material blank formed from paper and/or paper board material, forming at least one window element in the beverage cup material blank, constructing the beverage cup from the beverage cup material blank, and wherein said at least one window element comprises or consists of at least a partially transparent, biodegradable and/or compostable material.
